(19) United States
(12) Patent Application Publication
(10) Pub. No.: US 2026/0264742 A1
(43) Pub. Date: Sep. 10, 2026

(54) DUAL DRIVE ELECTRIC STEERING GEAR

(71) Applicant: Schaeffler Technologies AG & Co, KG., Herzogenaurach (DE)

(72) Inventors: Andrew Mlinaric, Lakeshore (CA); Timothy Jacques, Troy, OH (US); Andrew Lanni, Ray Twp, MI (US)

(73) Assignee: Schaeffler Technologies AG & Co, KG., Herzogenaurach (DE)

(21) Appl. No.: 19/071,941

(22) Filed: Mar. 6, 2025

(51) Int. Cl. B62D 5/04

(52) U.S. Cl. CPC B62D 5/0403; B62D 5/0445

(57) ABSTRACT

An electrically-powered steering gear assembly for steering a vehicle. The steering gear assembly includes a ball screw drive including a threaded spindle, a first drive unit for driving the threaded spindle, and a second drive unit for driving the threaded spindle. The threaded spindle includes a first end for receiving a steering input from a driver and a second end opposite the first end. The first drive unit and the second drive unit can be coupled to the second end of the threaded spindle.

### TECHNICAL FIELD

The present disclosure relates generally to a steering gear assembly, and more specifically an electrically-powered recirculating-ball steering gear assembly for steering a vehicle.

### BACKGROUND

In general, power steering systems are known structures used in vehicles to assist a driver of the vehicle in steering by adding power to that supplied by the driver and reducing the effort needed to turn a steering wheel manually. Prior electrically-powered recirculating-ball steering gear assemblies are complex and generally include a threaded spindle for driving a ball nut. The threaded spindle has a first end and a second end. A first drive system is in driving engagement with the first end of the threaded spindle and a second drive system is in driving engagement with the second end of the threaded spindle. This arrangement, where the first and second drive system are on opposite ends of the work shaft, is complex and bulky.

### SUMMARY

In accordance with one aspect, an electrically-powered steering gear assembly for steering a vehicle comprises a ball screw drive including a threaded spindle, a first drive unit for driving the threaded spindle, and a second drive unit for driving the threaded spindle. The threaded spindle includes a first end for receiving a steering input from a driver and a second end opposite the first end, and the first drive unit and the second drive unit are coupled to the second end of the threaded spindle.

Each of the first drive unit and the second drive unit can include a planetary reducer, and an output of each planetary reducer can be coupled to an input gear on the threaded spindle. The first drive unit and the second drive unit can be arranged such that the output of each planetary reducer is coupled to the input gear at diametrically opposed positions. A planetary reducer can be coupled to the second end of the threaded spindle, and the first drive unit and the second drive unit can be coupled to an input gear of the planetary reducer. The first drive unit and the second drive unit can be coupled to the input gear at diametrically opposed positions. Each of the first drive unit and the second drive unit can include an electric motor. Each electric motor can include an output shaft, and the output shafts of the electric motors and the threaded spindle can be aligned along parallel offset axes. Each electric motor can be independently operable to drive the threaded spindle.

In accordance with another aspect, an electrically-powered steering gear assembly for steering a vehicle comprises a ball screw including a threaded spindle, a first drive unit, a second drive unit, and a planetary reducer coupled to the threaded spindle. The first drive unit and the second drive unit can be coupled to an input gear of the planetary reducer. The first drive unit and the second drive unit can be coupled to the input gear at diametrically opposed positions. Each of the first drive unit and the second drive unit can include an electric motor. Each electric motor can include an output shaft, and the output shafts of the electric motors and the threaded spindle can be aligned along parallel offset axes. Each electric motor can be independently operable to drive the threaded spindle.

In accordance with another aspect, an electrically-powered steering gear assembly for steering a vehicle comprises a ball screw drive including a threaded spindle, a first drive unit, a second drive unit. The first drive unit and the second drive unit each include a planetary reducer, and an output of each planetary reducer is coupled to an input gear on the threaded spindle.

The output of the planetary reducer of the first drive unit and the second drive unit can be coupled to the input gear at diametrically opposed positions. Each of the first drive unit and the second drive unit can include an electric motor. Each electric motor can include an output shaft, and the output shafts of the electric motors and the threaded spindle can be aligned along parallel offset axes. Each electric motor can be independently operable to drive the threaded spindle.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a perspective view of an exemplary steering gear assembly in accordance with the present disclosure.

FIG. 2 is another perspective view of the exemplary steering gear assembly of FIG. 1.

FIG. 3 is a cross-sectional view taken through an axis of rotation of a threaded spindle of the exemplary steering gear assembly of FIG. 1.

FIG. 4 is an enlarged portion of FIG. 3.

FIG. 5 is a perspective view of another exemplary steering gear assembly in accordance with the present disclosure.

FIG. 6 is another perspective view of the exemplary steering gear assembly of FIG. 5.

FIG. 7 is a cross-sectional view taken through an axis of rotation of a threaded spindle of the exemplary steering gear assembly of FIG. 5.

FIG. 8 is an enlarged portion of FIG. 7.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

Embodiments according to this disclosure provide a compact dual drive electric steering gear.

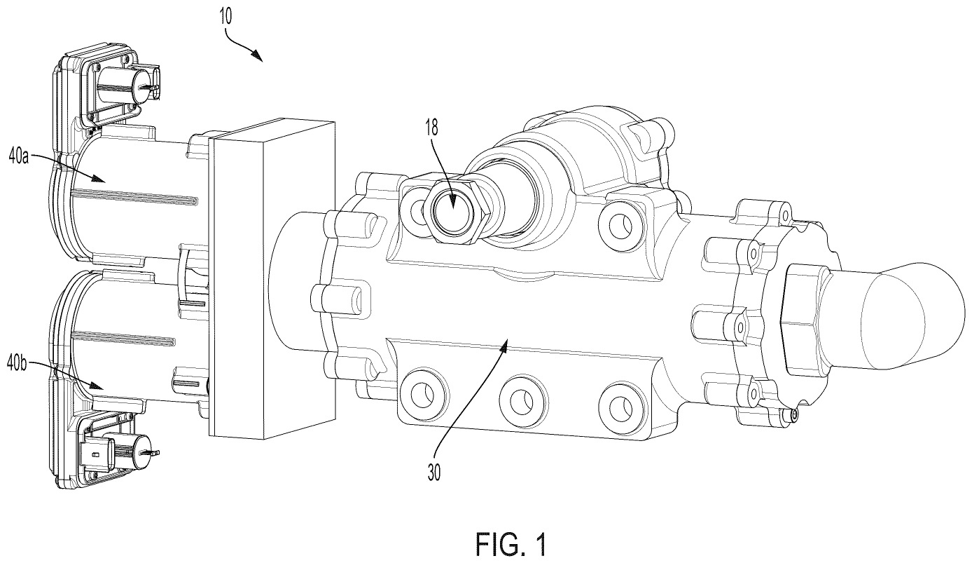

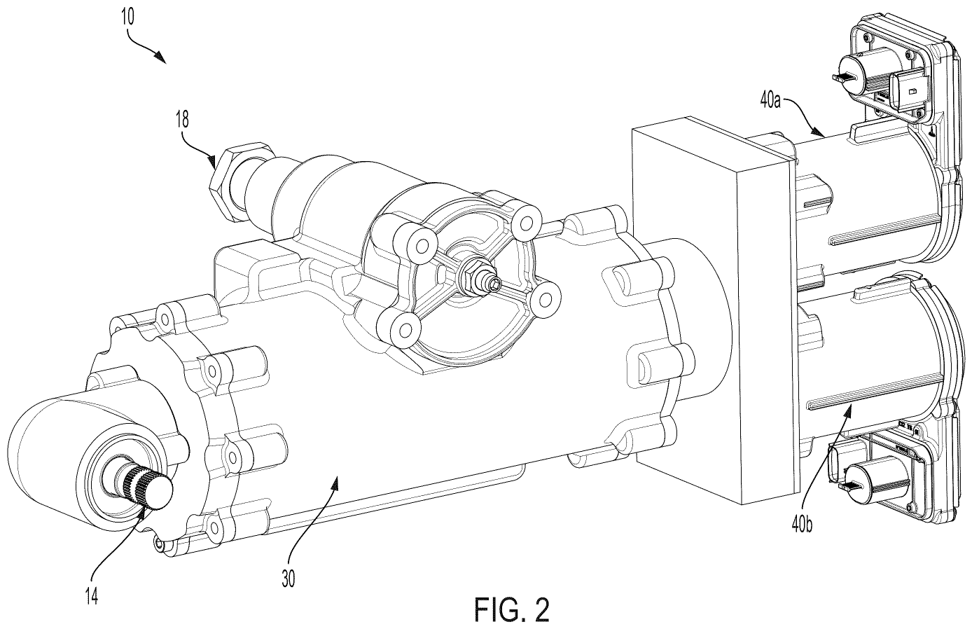

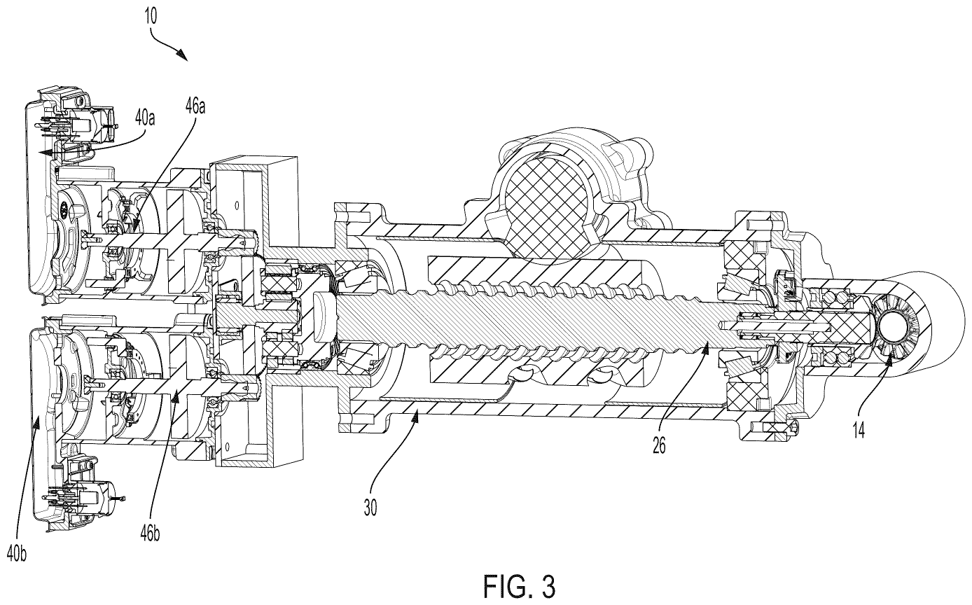

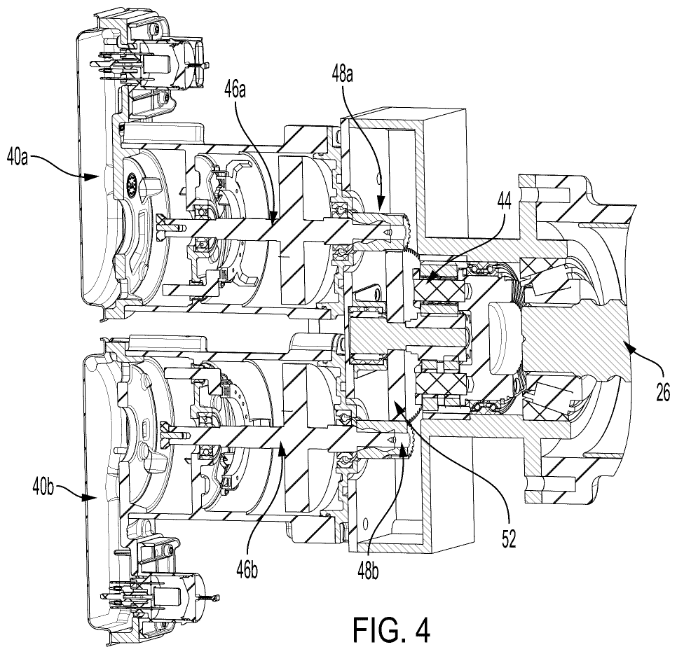

Referring to FIGS. 1-4, an exemplary steering gear in accordance with the present disclosure is illustrated and identified generally by reference numeral 10. The steering gear 10 includes an input shaft 14 for receiving an input from a steering wheel or other driver input, and an output shaft 18 also known as a Pitman arm connectable to the wheels of a vehicle. The input shaft 14, via two bevel gears, is coupled to a first end of a threaded spindle 26 of a ball screw drive 30 that also includes a ball nut 32 and balls 34. In an example embodiment, the ball screw drive 30 can be back driven; stated otherwise, the output shaft 18, via a response of the wheels interfacing with the road, can drive the input shaft 14 via the ball screw drive 30 and the threaded spindle 26. Rotation of the threaded spindle 26 in response to rotation of the input shaft 14 causes linear movement of the ball nut 32 via a known threaded interface between the threaded spindle 26 and the ball nut 32. Linear displacement of the ball nut 32 rotates the output shaft 18 in either a clockwise or counterclockwise direction to steer the wheels of the vehicle. In an example embodiment, the output shaft 18 is arranged orthogonally to the threaded spindle 26 and parallel to the input shaft 14; however, other suitable orientations of these components could also be implemented. In an example embodiment, a rotational range of the output shaft 18 is less than one revolution.

A second end of the threaded spindle 26 is coupled to first and second electric motors 40a and 40b via a planetary gearset 44. Each electric motor 40a/40b includes an output shaft 46a/46b having a spur gear 48a/48b meshed with an input gear 52 of the planetary gearset 44. The electric motors 40a and 40b are arranged such that spur gears 48a and 48b engage the input gear 52 at diametrically opposed positions. It will be appreciated that either electric motor 40a or 40b can independently drive the threaded spindle 26. In the illustrated example, the rotational axes of the output shafts 46a and 46b are parallel and offset from the rotational axis of the threaded spindle 26. In an example embodiment, the electric motors 40a, 40b are configured to provide steering assistance to a driver input that occurs at the steering wheel. This assistance is accomplished via a combined steering torque and angle sensor 54 arranged proximate to the first end of the threaded spindle 26. In an example embodiment, the combined steering torque and angle sensor 54 includes two angle sensors 58 and a torsion bar 56; other suitable sensors to measure torque and an angular position of the threaded spindle 26 may also be used. The combined steering torque and angle sensor 54 provides electronic feedback of: i) a steering torque that is applied to the threaded spindle 26 via the input shaft 14 (driver input), and ii) an angular position of the threaded spindle 26. This electronic feedback is communicated to an electronic controller, which, in turn, controls a speed and torque of each of the electric motors 40a, 40b to assist the driver in steering the wheels of the vehicle. In summary, the wheels are steered via torques applied to each end of the threaded spindle 26, one torque via the input shaft 14 (via the driver), and at least one further torque provided by the electric motors 40a, 40b via the planetary gearset 44.

In an example embodiment such as that for a driverless vehicle, the two electric motors 40a, 40b can be the sole providers of torque to the threaded spindle 26.

In an example embodiment, the two electric motors 40a, 40b can assist in providing a steering system feedback to the driver.

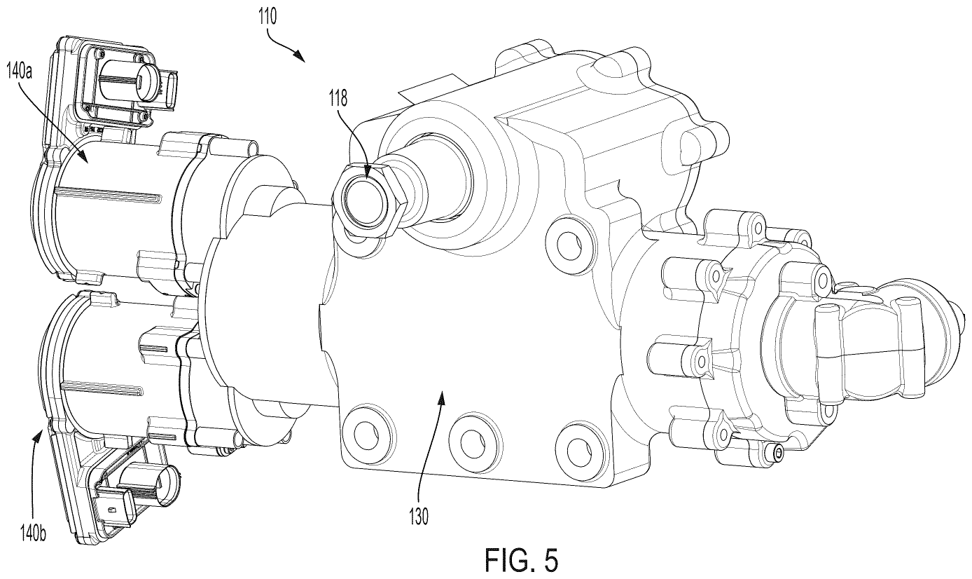

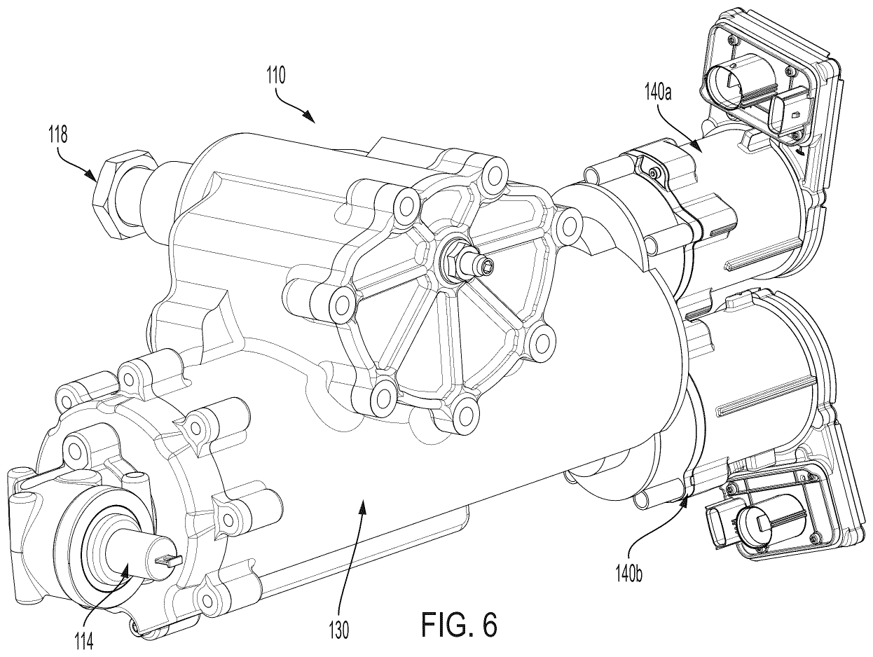

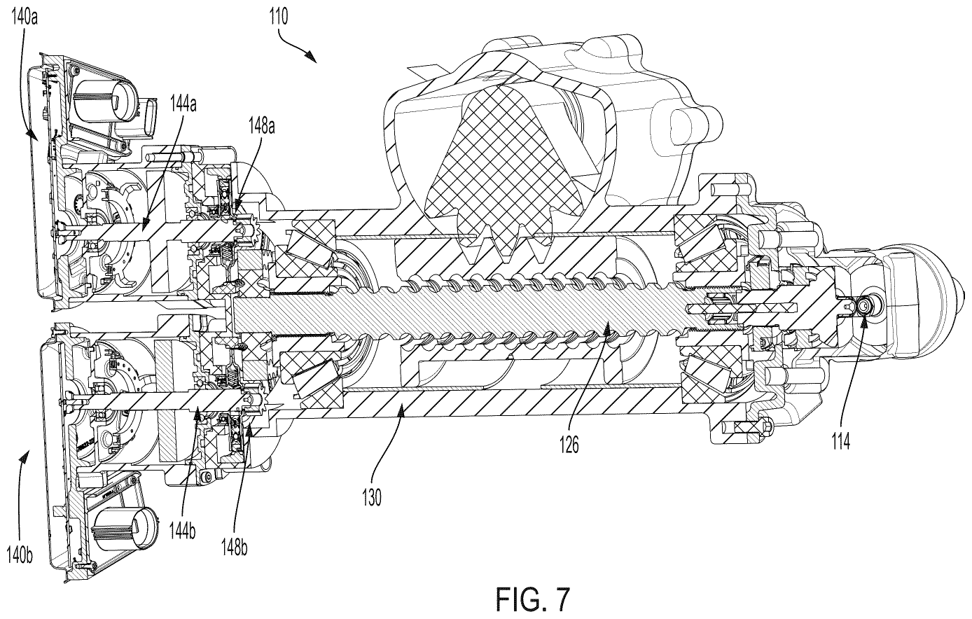

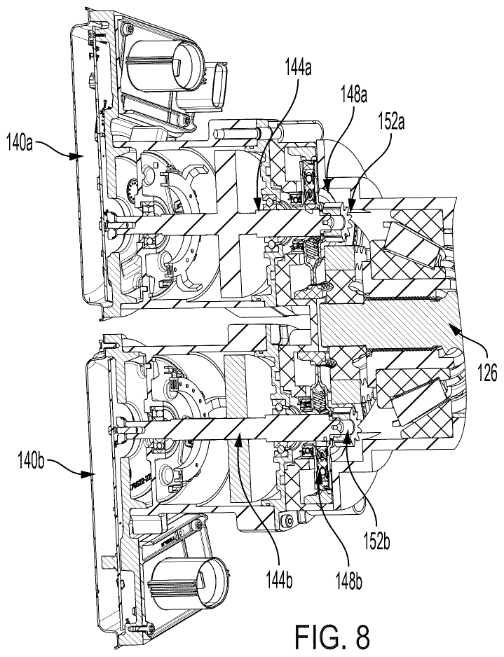

Turning to FIGS. 5-8, another exemplary steering gear in accordance with the present disclosure is illustrated and identified generally by reference numeral 110. The steering gear 110 includes an input shaft 114 for receiving an input from a steering wheel or other driver input, and an output shaft 118 (Pitman arm) connectable to the wheels of a vehicle. The input shaft 114, via two bevel gears, is coupled to a first end of a threaded spindle 126 of a ball screw drive 130 that also includes a ball nut 132 and balls 134. In an example embodiment, the ball screw drive 130 can be back driven. Rotation of the threaded spindle 126 in response to rotation of the input shaft 114 causes linear movement of the ball nut 132 via a known threaded interface between the threaded spindle 126 and the ball nut 132. Linear displacement of the ball nut 132 rotates the output shaft 118 via a geared interface that includes a sector gear 136 of the output shaft 118 (Pitman arm) and teeth 138 arranged on the ball nut 132.

A second end of the threaded spindle 126 is coupled to first and second electric motors 140a and 140b via an input gear 144. Each electric motor 140a/140b includes an output shaft 144a/144b coupled to a planetary reducer 148a/148b. Each planetary reducer 148a/148b includes an output gear 152a/152b coupled to input gear 144 at diametrically opposed positions. It will be appreciated that either electric motor 140a or 140b can independently drive the threaded spindle 126. In an example embodiment, the electric motors 140a, 140b are configured to provide steering assistance to the driver input at the steering wheel via a combined steering torque and angle sensor 154 that includes a torsion bar 156 and two angle sensors 158. Electronic feedback from the combined steering torque and angle sensor 154 is utilized like that of the earlier described combined steering torque and angle sensor 54, therefore, further discussion is not necessary.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 steering gear
14 input shaft
18 output shaft
26 threaded spindle
30 ball screw drive
32 ball nut
34 balls
40a electric motor
40b electric motor
44 planetary gearset
46a output shaft
46b output shaft
48a spur gear
48b spur gear
52 input gear
54 combined steering torque and angle sensor
56 torsion bar
58 angle sensors
110 steering gear
114 input shaft
118 output shaft
116 threaded spindle
130 ball screw drive
132 ball nut
134 balls
136 sector gear
138 teeth
140a electric motor
140b electric motor
144a output shaft
144b output shaft
148a planetary reducer
148b planetary reducer
152a output gear
152b output gear
154 combined steering torque and angle sensor
156 torsion bar
158 angle sensors

What is claimed is:

1. An electrically-powered steering gear assembly for steering a vehicle comprising:
a ball screw drive including a threaded spindle;
a first drive unit for driving the threaded spindle; and
a second drive unit for driving the threaded spindle;
wherein the threaded spindle includes a first end configured for receiving a steering input from a driver and a second end opposite the first end; and
wherein the first drive unit and the second drive unit are coupled to the second end of the threaded spindle.

2. The steering gear assembly according to claim 1, wherein each of the first drive unit and the second drive unit includes a planetary reducer, and wherein an output of each planetary reducer is coupled to an input gear on the threaded spindle.

3. The steering gear assembly according to claim 2, wherein the first drive unit and the second drive unit are arranged such that the output of each planetary reducer is coupled to the input gear at diametrically opposed positions.

4. The steering gear assembly according to claim 1, further comprising a planetary reducer coupled to the second end of the threaded spindle, wherein the first drive unit and the second drive unit are coupled to an input gear of the planetary reducer.

5. The steering gear assembly according to claim 4, wherein the first drive unit and the second drive unit are coupled to the input gear at diametrically opposed positions.

6. The steering gear assembly according to claim 1, wherein each of the first drive unit and the second drive unit includes an electric motor.

7. The steering gear assembly according to claim 6, wherein each electric motor includes an output shaft, and wherein the output shafts of the electric motors and the threaded spindle are aligned along parallel offset axes.

8. The steering gear assembly according to claim 6, wherein each electric motor is independently operable to drive the threaded spindle.

9. An electrically-powered steering gear assembly for steering a vehicle comprising:
a ball screw drive including a threaded spindle;
a first drive unit;
a second drive unit; and
a planetary reducer coupled to the threaded spindle, wherein the first drive unit and the second drive unit are coupled to an input gear of the planetary reducer.

10. The steering gear assembly according to claim 9, wherein the first drive unit and the second drive unit are coupled to the input gear at diametrically opposed positions.

11. The steering gear assembly according to claim 9, wherein each of the first drive unit and the second drive unit includes an electric motor.

12. The steering gear assembly according to claim 11, wherein each electric motor includes an output shaft, and wherein the output shafts of the electric motors and the threaded spindle are aligned along parallel offset axes.

13. The steering gear assembly according to claim 11, wherein each electric motor is independently operable to drive the threaded spindle.

14. An electrically-powered steering gear assembly for steering a vehicle comprising:
a ball screw drive including a threaded spindle;
a first drive unit;
a second drive unit; and
wherein the first drive unit and the second drive unit each include a planetary reducer, and wherein an output of each planetary reducer is coupled to an input gear on the threaded spindle.

15. The steering gear assembly according to claim 14, wherein the output of the planetary reducer of the first drive unit and the second drive unit are coupled to the input gear at diametrically opposed positions.

16. The steering gear assembly according to claim 14, wherein each of the first drive unit and the second drive unit includes an electric motor.

17. The steering gear assembly according to claim 16, wherein each electric motor includes an output shaft, and wherein the output shafts of the electric motors and the threaded spindle are aligned along parallel offset axes.

18. The steering gear assembly according to claim 16, wherein each electric motor is independently operable to drive the threaded spindle.
